(19) United States
(12) Patent Application Publication
(10) Pub. No.: US 2007/0125058 A1
(43) Pub. Date: Jun. 7, 2007

(54) Rake

(76) Inventor: Jim Clifton, Jacksonville, FL (US)

Correspondence Address: ROGERS TOWERS, P.A., 1301 RIVERPLACE BOULEVARD, SUITE 1500, JACKSONVILLE, FL, 32207, US

(21) Appl. No.: 11/294,773

(22) Filed: Dec. 6, 2005

(51) Int. Cl. A01D 7/00

(52) U.S. Cl. 56/400.16

(57) ABSTRACT

A rake having an upper rake head and relatively stiff tines and a lower rake head having shorter, relatively flexible tines, wherein the separation distance between the upper tines and the lower tines is adjustable. The upper rake head and tines perform in the manner of a typical garden rake, while the lower rake head and tines perform in the manner of a typical leaf rake. The rake heads and tines can be used separately or in combination.

### BACKGROUND OF THE INVENTION

This invention relates generally to the field of long-handled implements or tools commonly referred to as leaf rakes or garden rakes, and more particularly relates to such devices having multiple rake heads and multiple sets of tines.

Rakes are typically produced in two types. A leaf or lawn rake typically comprises a plurality of aligned tines extending from a rake head, to which is connected an elongated handle. The tines are relatively thin and flexible, and have bent tip portions at the free end. This type of rake is primarily suited for raking leaves, grass clippings or other small debris from grass lawns, as the flexibility and thinness of the tines allows them to pass through the grass causing little or no damage. Although it is possible to manufacture such leaf rakes out of plastic, the rakes are typically composed of metal for strength and durability. In contrast, a garden or bow rake typically comprises a plurality of rigid tines that extend perpendicularly from a frame forming the rake head. The garden rake is designed for moving piles of objects, tilling soil, etc. and is not suitable for use on grass lawns, as the inflexibility of the tines damages the grass roots or runners. As with the leaf rakes, the garden rakes are usually formed of metal, but stiff and relatively thick plastic may also be used to produce a rake less damaging to surfaces.

While the design of a leaf rake is well suited for gathering leaves, clippings and the like from grassy areas, the inherent flexibility of the tines that produce optimum efficiency in these raking operations is not suited for moving large piles of gathered debris, whether during the raking operation on the grass or after piles of leaves and the like have been gathered. Prior attempts have been made to address this problem, with the proposed solution usually involving rakes having multiple sets of tines. For example, U.S. Pat. No. 1,591,738 to Bell shows a rake having a set of rigid tines extending perpendicularly from the rake head and a set of flexible tines extending generally forward from the rake head in planar manner and to the front of the rigid tines. This design is essentially a combination rake, in that the tines are used separately depending on the task to be performed. Another combination rake is shown in U.S. Pat. No. 3,264,810 to Lowell, with the rake having a set of relatively rigid, upwardly extending, short tines mounted to the upper side of the flexible tines comprising a leaf rake, whereby inverting the rake allows it to be used in the manner of a garden rake. U.S. Pat. No. 4,667,458 to Barrett shows a construction similar to the Bell patent, but wherein a series of larger profile bars are utilized instead of a series of rigid tines, the bars acting to move piles of leaves or the like during the raking operation. Other patents show staggered rows of flexible tines, such as U.S. Pat. No. 3,332,223 to Polisso and U.S. Pat. No. 4,744,208 to King, U.S. Pat. No. 5,099,638 to Bass, and U.S. Patent RE 35,604 to McDonough, Jr., or staggered rows or rigid tines, such as U.S. Pat. No. 1,715,613 to McFadden and U.S. Pat. No. 4,351,145 to Frakas. None of these patents provide a rake structure that enables the rake to be utilized as both a leaf rake and a garden rake while optimizing efficiency and ease of use.

It is an object of this invention to provide a rake that addresses the problems set forth above, wherein the rake has the functionality of both a leaf rake and a garden rake, wherein a set of rigid tines and a set of flexible tines are present, the rigid and flexible tines being relatively disposed in a manner that allows the separation distance and angle to be adjusted as desired to determine the amount of cooperation between the two sets of tines during the raking operation.

### SUMMARY OF THE INVENTION

The invention comprises a rake having an elongated handle and a pair of generally planar rake heads, one rake head having a plurality of relatively rigid or stiff tines, such as typically provided in a garden rake, and a second generally planar rake head having a plurality of relatively flexible tines, such as typically provided in a leaf rake, the second rake head being mounted beneath the first rake head in a manner whereby preferably the rake heads are not in parallel and whereby the two rake heads can be adjusted to increase or decrease the angle between the two rake heads and/or the separation distance. The rake head adjustment means may comprise, for example, a threaded rod and threaded nut in combination, with the rod passing through both rake heads. The stiff tines extend farther forward than the flexible tines and comprise tip portions preferably joined substantially perpendicularly to relatively stiff shank members, while the tip portions of the flexible tines preferably are connected to relatively flexible shank members at a non-perpendicular angle. Biasing means to maintain the rake heads at a chosen separation distance during use with a desired amount of tension or compression, such as a spring mounted onto the threaded rod, is provided.

At maximum separation of the rake heads the rake functions primarily as a leaf rake, since the stiff tines are disposed well above the ground surface. At minimum separation the rake functions primarily as a garden rake, since the tips of the flexible tines will have minimal ground contact. At separation distances between maximum and minimum both the flexible tines and the rigid tines are operational, with the flexible tines acting as a support to maintain the rigid tines a desired height above the ground surface, dependent on the type of material being raked and the condition and type of ground surface. In this manner the amount of downward pressure needed to cause the rigid tines to become operational in conjunction with the flexible tines may be varied as required.

Preferably, a transverse deflector shield extends across the far ends of the stiff tines behind the tip portions to cover the area between the rigid tip portions and the flexible tip portions to prevent debris kicked up by the flexible tines from passing through the rake during use. The tines and rake heads may be composed of metal, plastic, bamboo or any other material having suitable physical characteristics of rigidity, flexibility, durability and strength well known in the rake art. The handle may be straight, curved or ergonomically shaped.

### BRIEF DESCRIPTION OF THE DRAWINGS

FIG. 1 is a top view showing primarily the first or upper rake head and the stiff tines.

FIG. 2 is a bottom view showing the second or lower rake head and flexible tines, along with the rigid tines and tip portions.

FIG. 3 is a partial cross-sectional side view taken along Line III-III of FIG. 1, showing the rake heads, the flexible tines and the rigid tines, and further illustrating by dashed lines a configuration with the rigid tines and flexible tines separated a maximum distance.

FIG. 4 is a partial cut-away view similar to FIG. 1, showing the lower rake head and flexible tines as exposed as depicted on an embodiment with no deflector shield.

FIG. 5 is a partial front view showing the tip portions of the rigid tines.

### DETAILED DESCRIPTION OF THE INVENTION

With reference to the drawings, the invention will now be described in detail with regard for the best mode and the referred embodiments. In a broad general sense, the invention is a rake comprising two rake heads, an upper rake head that is relatively stiff and has the characteristics of a garden rake, and a lower rake head that is relatively flexible and has the characteristics of a leaf rake.

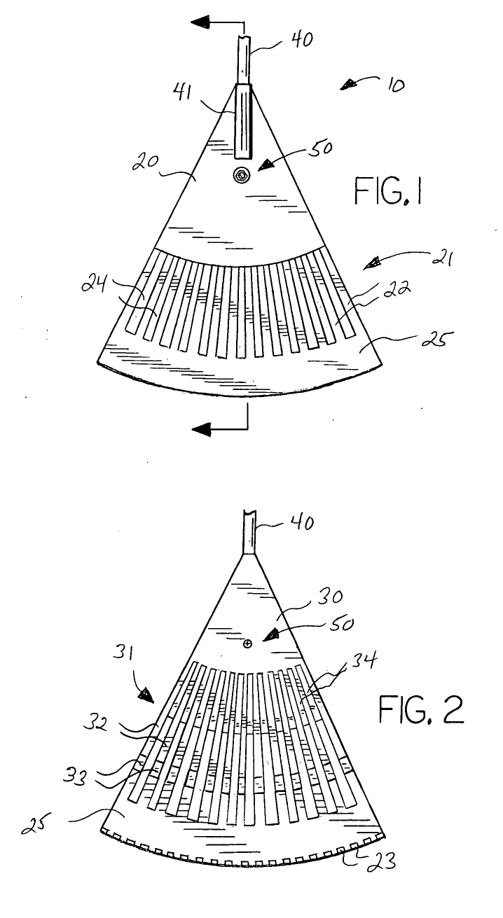

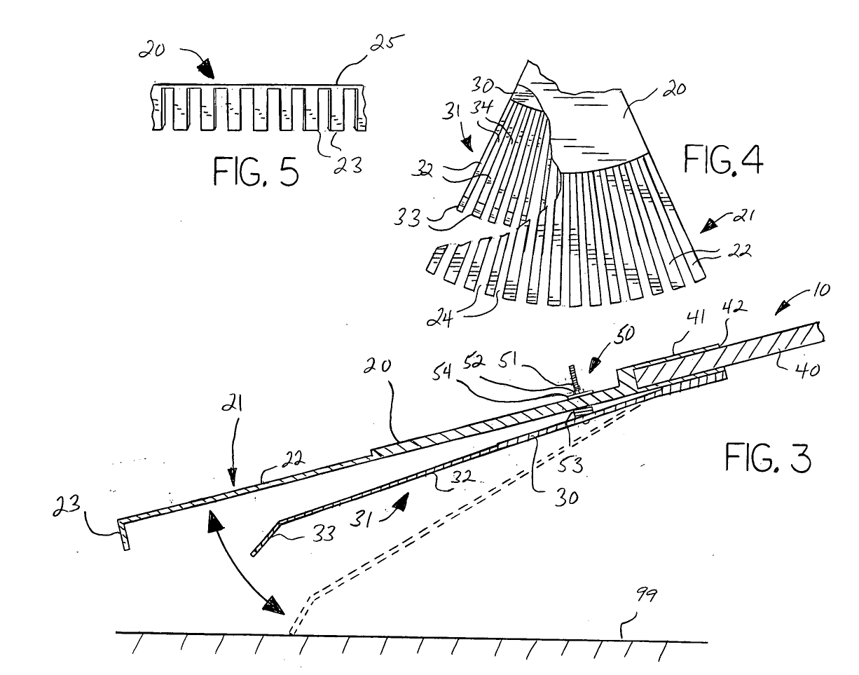

The invention is a rake 10 comprising a handle 40, an upper rake head 20 and a lower rake head 30. The handle 10 is joined to one or both of the rake heads 20 and 30 in suitable known manner. As shown in FIGS. 1 and 3, the handle 10 may be joined using handle attachment means 41 disposed on upper rake head 20, the handle attachment means 41 comprising for example a handle receiving bore 42. The handle 10 may comprise any suitable shape, such as straight, curved or ergonomically shaped. The upper rake head 20 and lower rake head 30 are joined together in a non-parallel manner, preferably near the handle attachment means 41, using mechanical fasteners, adhesive bonding, welding, etc. The rake heads 20 and 30 are joined in a manner that allows the angle between the upper rake head 20 and the lower rake head 30 to be adjusted and altered. Preferably, the rake heads 20 and 30 are generally planar, and upper rake head 20 is stiffer than lower rake head 30. The rake heads 20 and 30 may be generally triangular as shown in the figures or may have differing shapes.

Extending forward from the upper rake head 30 in the direction opposite to the handle 10 are a plurality of elongated, stiff tines 21, each tine 21 comprising a shank or shaft 22 and a tip, end or prong member 23, the tines 21 being separated from each other by slots 24. Preferably, the end members 23 are mounted generally perpendicularly to the shanks 22, but this is not required. The upper rake head 20 and the tines 23 are constructed from suitable material and suitably designed so as to be relatively stiff in comparison to the lower rake head 30 and its tines 33, whereby the upper rake head 20 and its tines 23 function in a manner that is equivalent to the type of rake commonly referred to as a garden rake, there being reduced springiness in the action of the rake while it is use. In a preferred embodiment, a deflector shield member 25 is disposed transversely across the shanks 22 adjacent the tip members 23, such that the deflector shield 25 lies between the tip members 33 of the lower tines 31 and the end members of the upper tines 21. This deflector shield member 25 prevents leaves or debris that has been kicked up from the lower tines 31 from passing through the slots 24, acts to reduce flexibility in the tines 21, and functions as a scoop or blade when the rake 10 is being used to move large masses of debris or leaves.

Extending forward from the lower rake head 30 in the direction opposite to the handle 10 are a plurality of elongated, flexible tines 31, each tine 31 comprising a shank or shaft 32 and a tip, end or prong member 33, the tines 31 being separated from each other by slots 34. Preferably, the end members 33 are mounted non-perpendicularly to the shanks 32, but this is not required. The lower rake head 30 and the tines 33 are constructed from suitable material and suitably designed so as to be relatively flexible in comparison to the upper rake head 20 and its tines 23, whereby the lower rake head 30 and its tines 33 function in a manner that is equivalent to the type of rake commonly referred to as a leaf rake, the increased springiness in the action of the rake while it is use allowing it to be used in grass. The combination of lower rake head 30 and tines 31 are shorter than the combination of upper rake head 20 and tines 21, such that the tip members 23 of the upper tines 21 extend beyond the tip members 33 of the lower tines 31, as shown in FIG. 4.

Rake head adjustment means 50, best seen in FIG. 3, are provided such that the angle and separation distance between the upper rake head 20 and tines 21 and the lower rake head 30 and tines 31 can be increased or decreased as desired. As shown in the figures, the rake head adjusting means 50 may comprise in combination a threaded rod 51 that passes through the upper and lower rake heads 20 and 30, which is secured by a threaded nut 52 and washer 54. Preferably, a spring member 53 is disposed between the upper rake head 20 and the lower rake head 30. Spring member 53 maintains the desired amount of separation between the rake heads 20 and 30, while simultaneously allowing rake head adjustment means 50 to additionally function as a means to control the relative tension and compression between the rake heads 20 and 30.

The rake 10 as described serves multiple functions, as well as improving on the functionality of standard rakes. If the rake 10 is to be used primarily in the manner of a garden rake, the rake head adjustment means 50 is contracted such that the lower rake head 30 and its tines 31 are brought close to the upper rake head 20 and its tines 21. Because the upper tines 31 extend a greater distance than the lower tines 21, only the relatively rigid, stiff tines 21 contact the grass, concrete or other ground surface 99, with the flexible lower tines 31 serving no or at most minimal purpose. If the rake 10 is to be used in the manner of a leaf rake, the rake head adjustment means 50 is expanded such that the upper rake head 20 and its tines 21 are separated a maximum distance from the lower rake head 30 and its tines 31, such that only the flexible tines 31 contact the ground surface 99.

The primary functionality of the rake 10, however, utilizes both sets of tines 21 and 31 simultaneously, with the rake head adjustment means 50 being adjusted into a middle position. In this configuration, both the flexible tines 31 and the stiff tines 21 act to move leaves, debris or the like. The tip members 33 of the flexible lower tines 31 are able to extend into grass, while the tip members 23 of the stiff upper lines 21 are maintained a short distance above by the biasing or spring-like effect of flexible tines 31. In this manner the lower tines 31 remove debris from within the grass while the upper tines 21 serve to rake or move the larger debris that resides on the top of the grass or the smaller debris that has been kicked up by the lower tines 31. By adjusting the rake head adjustment means 50, the separation distance between the upper tines 21 and lower tines 31 is altered, such that the resident height of the upper tines 21 can be adjusted in response to the grass height to prevent damage to the grass from the relatively stiff tines 21. In addition, the user can alter the angle of the handle 40 to increase of decrease the amount of ground contact by the tines 21 and 31.

It is understood that equivalents and substitutions to certain elements set forth above may be obvious to those skilled in the art, and thus the true scope and definition of the invention is to be as set forth in the following claims.

1. A rake comprising a handle, a first rake head connected to said handle, a first set of tines connected to said first rake head, a second rake head connected to said first rake head, said first rake head and said second rake head defining an angles, said second rake head connected to said first rake head in a hinged manner whereby said angle between said first rake head and said second rake head can be adjusted, and a second set of tines connected to said second rake head;
wherein said second set of tines connected to said second rake head are more flexible than said first set of tines connected to said first rake head.

2. The rake of claim 1, wherein said first set of tines connected to said first rake head extend farther than said second set of tines connected to said second rake head.

3. The rake of claim 2, further comprising rake head adjustment means for adjusting the angle between said first rake head and said second rake head.

4. The rake of claim 3, said rake head adjusting means comprising a spring member disposed between said first rake head and said second rake head.

5. The rake of claim 4, said rake head adjusting means further comprising a threaded rod and a threaded nut.

6. The rake of claim 2, each of said first set of tines connected to said first rake head comprising a tip member connected to an elongated shank, and each of said second set of tines connected to said second rake head comprising a tip member connected to an elongated shank.

7. The rake of claim 6, wherein said tip members of said first set of tines connected to said first rake head are joined to said shanks of said first rake head approximately perpendicularly, while said tip members of said second set of tines connected to said second rake head are joined to said shanks of said second rake head non-perpendicularly.

8. The rake of claim 2, further comprising a deflection shield disposed across said first set of tines connected to said first rake head, said deflection shield being positioned farther than said second set of tines of said second rake head.

9. A rake comprising:
a first rake head;
elongated tines connected to said first rake head;
a second rake head connected to said first rake head beneath and at an angle to said first rake head; and
elongated tines connected to said second rake head;
wherein said second rake head tines are more flexible than said first rake head tines, and wherein said first rake head tines extend farther than said second rake head tines.

10. The rake of claim 9, further comprising rake head adjustment means for adjusting the angle between said first rake head and said second rake head, whereby said second rake head is adjustably connected to said first rake head such that the separation distance between said first rake head tines and said second rake head tines can be changed.

11. The rake of claim 10, wherein said rake head adjustment means comprises a spring member disposed between said first rake head and said second rake head.

12. The rake of claim 11, wherein said rake head adjustment means further comprising a threaded rod and a threaded nut.

13. The rake of claim 9, each of said first rake head tines comprising a tip member connected to an elongated shank, and each of said second rake head tines comprising a tip member connected to an elongated shank.

14. The rake of claim 13, wherein said tip members of said first rake head tines are joined to said shanks of said first rake head approximately perpendicularly, while said tip members of said second rake head tines are joined to said shanks of said second rake head non-perpendicularly.

15. The rake of claim 13, further comprising a deflection shield disposed across said first rake head tines, said deflection shield extending between said first rake tip members and said second rake tip members.

16. A rake comprising:
a first an rake head;
elongated tines connected to said first rake head, each of said first rake head tines comprising a tip member connected to an elongated shank;
a second rake head hingedly connected to said first rake head at an angle;
elongated tines connected to said second rake head, each of said second rake head tines comprising a tip member connected to an elongated shank;
rake head adjustment means, whereby said second rake head is adjustably connected to said first rake head such that the angle between said first rake head and said second rake head can be changed and such that the separation distance between said first rake head tines and said second rake head tines can be changed, said rake head adjustment means comprising a spring member disposed between said first rake head and said second rake head;
wherein said second rake head tines are more flexible than said first rake head tines, and wherein said first rake head tines extend farther than said second rake head tines.

17. The rake of claim 16, wherein said tip members of said first rake head tines are joined to said shanks of said first rake head approximately perpendicularly, while said tip members of said second rake head tines are joined to said shanks of said second rake head non-perpendicularly.

18. The rake of claim 16, further comprising a deflection shield disposed across said first rake head tines, said deflection shield extending between said first rake tip members and said second rake tip members.
